(19) United States
(12) Patent Application Publication
(10) Pub. No.: US 2015/0063519 A1
(43) Pub. Date: Mar. 5, 2015

(54) Method for Measuring Primary Coolant Flow in a Fluoride Salt Cooled High Temperature Reactor

(71) Applicant: UT-Battelle, LLC, Oak Ridge, TN (US)

(72) Inventor: David E. Holcomb, Oak Ridge, TN (US)

(21) Appl. No.: 14/012,231

(22) Filed: Aug. 28, 2013

(51) Int. Cl. G21C 17/032

(52) U.S. Cl. CPC G21C 17/032
USPC 376/246

(57) ABSTRACT

This invention relates to the field of coolant flow in a fluoride salt cooled high temperature reactor. In particular, the invention relates to the discovery of use of nitrogen-16 and/or fluoride-20 decay signature to measure coolant flow. The method of the invention comprises detecting gamma radiation emanating from nitrogen-16 activity and/or fluorine-20 activity within the reactor coolant at a first position along the reactor coolant loop; detecting the gamma radiation emanating from the nitrogen-16 activity and/or fluorine-20 activity within the reactor coolant at a second position along the reactor coolant loop downstream of said first position. The gamma radiation detected from the first position and second position are then cross-correlated, thereby determining the transit time of corresponding gamma activity perturbations viewed at the two detector locations.

### STATEMENT REGARDING FEDERALLY SPONSORED RESEARCH

The U.S. Government has rights in this invention pursuant to contract no. DE-AC05-000R22725 between the United States Department of Energy and UT-Battelle, LLC.

### FIELD OF THE INVENTION

This invention relates to the field of coolant flow in a fluoride salt cooled high temperature reactor. In particular, the invention relates to the discovery of use of nitrogen-16 and/or fluoride-20 decay signature to measure coolant flow.

### BACKGROUND OF THE INVENTION

Fluoride salt cooled high temperature reactors are a class of fission reactors that use liquid fluoride salt as primary coolant. Measuring the primary coolant flow at a fluoride salt cooled high temperature reactor is required to operate the plant.

One method for measuring primary coolant flow at a fluoride salt cooled high temperature reactor is to correlate the pressure drop across a flow obstruction (such as a Venturi orifice) with the flow rate. However, the accuracy of differential pressure based flowmeters is vulnerable to corrosion of the obstruction changing the pressure drop. Furthermore, differential pressure flowmeters become less accurate with flow stratification and non-uniformity of the flow pattern. Moreover, high temperature, molten salt compatible differential pressure taps are technically challenging.

Another method is to employ an ultrasonic transit time flowmeter from the exterior of the piping. However, ultrasonic flowmeters are vulnerable to flow stratification and non-uniformities. Furthermore, ultrasonic flowmeters also require modification to separate their thermally sensitive elements from the high temperature environment.

Thus, the environmental conditions of the flow make measuring the primary coolant flow especially challenging. Therefore, it would be beneficial to provide a method for measuring the primary coolant flow in a fluoride salt cooled high temperature reactor.

### SUMMARY OF THE INVENTION

These and other objectives have been met by the present invention, which provides a method for measuring the coolant flow rate within a coolant loop of a fluoride salt cooled high temperature reactor.

In one embodiment, the method comprises detecting gamma radiation emanating from nitrogen-16 activity and fluorine-20 activity within the reactor coolant at a first position along the reactor coolant loop; detecting the gamma radiation emanating from the nitrogen-16 activity and fluorine-20 activity within the reactor coolant at a second position along the reactor coolant loop downstream of said first position.

In another embodiment, the method comprises detecting gamma radiation emanating from nitrogen-16 activity within the reactor coolant at a first position along the reactor coolant loop; detecting the gamma radiation emanating from nitrogen-16 activity within the reactor coolant at a second position along the reactor coolant loop downstream of said first position.

In yet another embodiment, the method comprises detecting gamma radiation emanating from fluorine-20 activity within the reactor coolant at a first position along the reactor coolant loop; detecting gamma radiation emanating from fluorine-20 activity within the reactor coolant at a second position along the reactor coolant loop downstream of said first position.

The gamma radiation detected from the first position and second position are then cross-correlated, thereby determining the transit time of corresponding gamma activity perturbations viewed at the two detector locations.

### BRIEF DESCRIPTION OF THE FIGURES

FIG. 1. Schematic of gamma detectors rings (1) spaced at a known distance along a coolant loop pipe of a fluoride salt-cooled high temperature reactor.

FIG. 2. Decay scheme of nitrogen-16.

FIG. 3. Decay scheme of fluorine-20.

FIG. 4. Neutron cross-sections and representative fluoride salt cooled high temperature reactor core neutron flux.

### DETAILED DESCRIPTION OF THE INVENTION

The invention is based on the surprising discovery by the inventor of the use of nitrogen-16 and/or fluorine-20 decay signature to measure coolant flow. Throughout this specification, parameters are defined by maximum and minimum amounts. Each minimum amount can be combined with each maximum amount to define a range.

The invention provides a method for measuring the primary coolant flow rate within a coolant loop of a fluoride salt cooled high temperature reactor. As used herein, the term “fluoride salt cooled high temperature reactor” refers to a nuclear reactor that uses fluoride salt as the primary coolant.

Examples of fluoride salts useful in fluoride salt cooled high temperature reactors include, for example, binary or ternary mixtures of fluoride salts. Such mixtures of fluoride salts generally are highly chemically stable fluids with low vapor pressure and good heat transfer properties. An example of a primary coolant for a fluoride salt cooled high temperature reactor is flibe, a 67-33 weight percent mixture of isotopically separated lithium-7 fluoride and beryllium fluoride. Other examples of primary coolants include those fluoride salts listed in Table 2 in Oak Ridge National Laboratory document ORNL/™-2006/12 titled “Assessment of Candidate Molten Salt Coolants for the Advanced High-Temperature Reactor (AHTR),” which is hereby incorporated by reference.

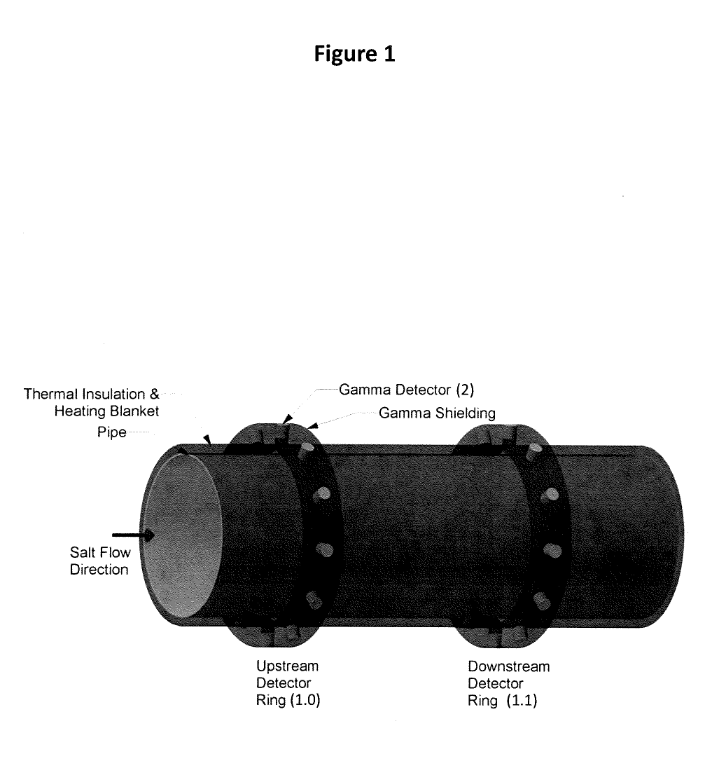

The coolant loop of a fluoride salt cooled high temperature reactor employs at least two gamma detectors rings (1.0 and 1.1) spaced at a known distance along the reactor coolant loop pipe. See FIG. 1. Each gamma detector ring can contain one or more gamma detector(s) (2).

The method for measuring the primary coolant flow rate within a coolant loop comprises detecting gamma radiation emanating from nitrogen-16 activity and/or fluorine-20 activity within the reactor coolant at a first position along the reactor coolant loop. The first position may be referred to herein as the “upstream detector ring” (1.0).

The next step of the method comprises detecting the gamma radiation emanating from nitrogen-16 activity and/or fluorine-20 activity within the reactor coolant at a second position along the reactor coolant loop downstream of the first position. The second position may be referred to herein as the “downstream detector ring” (1.1).

The fluorine-19 of the primary coolant reacts with the reactor core's neutron flux via two separate activation reactions, which are as follows:

¹⁹F(n,α)¹⁶N

¹⁹F(n,γ)²⁰F

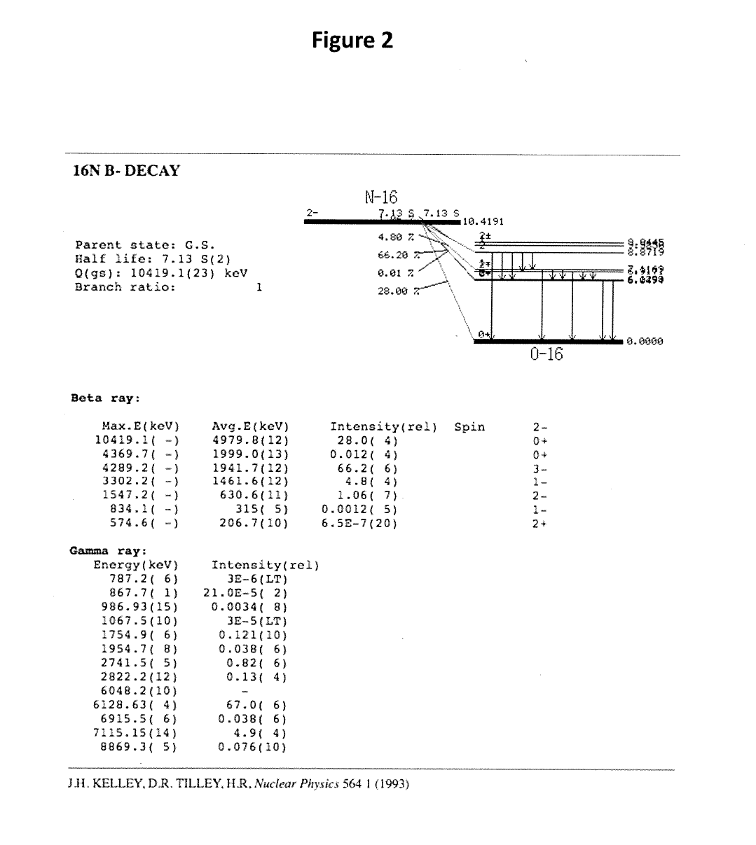

Nitrogen-16 has a 7.13 second half-life and emits a 6.123 MeV gamma ray with an intensity of 67% during its decay. Nitrogen-16 also emits a 7.115 MeV gamma ray with 4.9% intensity during its decay. The decay scheme of nitrogen-16 is shown in FIG. 2.

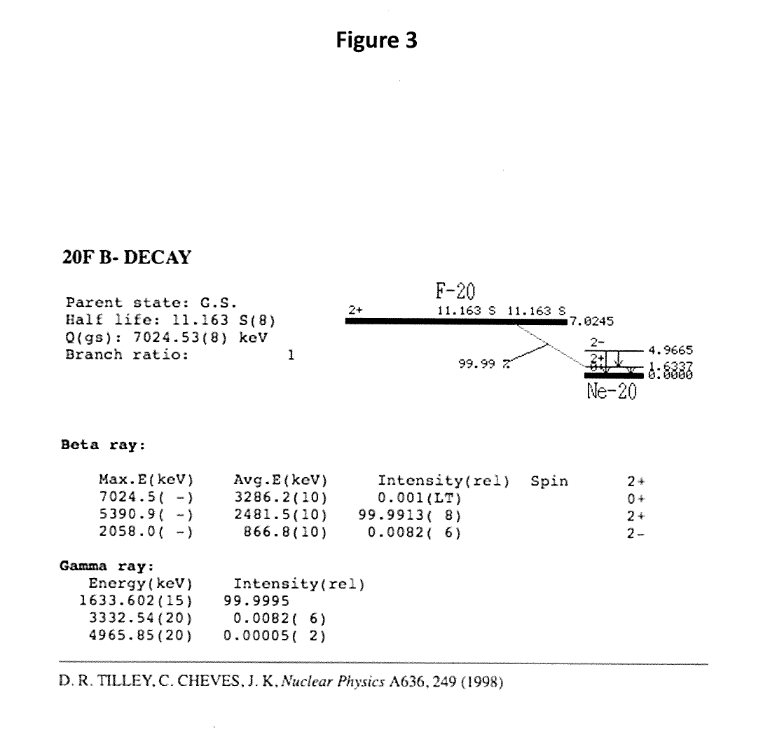

Fluorine-20 has a half-life of 11.163 seconds and emits a gamma ray of 1.643 MeV with an intensity of over 99.99% during its decay. The decay scheme of fluorine-20 is shown in FIG. 3.

The primary coolant flow rate is calculated by measuring the nitrogen-16 and/or the fluorine-20 activity at two known locations along the primary loop piping. By measuring the delay time between two positions along the primary loop piping, the flow rate can be determined. The outputs of the two detector sets (i.e., upstream detector ring and downstream detector ring) are cross-correlated to determine the transit time of corresponding gamma activity perturbations viewed at the two detector locations. For example, the basic measurement method is described by Gopal and Weiss in U.S. Pat. No. 3,818,231 for water-cooled nuclear reactors, which is incorporated herein by reference.

The improvements over the prior art are 1) that primary coolant activation occurs to a much greater extent for fluoride salt cooled reactors enabling higher accuracy primary loop flow measurements, 2) that the difference in decay time and gamma energy between nitrogen-16, and fluorine-20, provides two sets of signals thereby increasing the measurement accuracy, 3) use of a multiplicity of detectors located in rings around the primary coolant piping can provide flow distribution information, and 4) the absorption path length difference between the gamma energies of the fluorine-20 and nitrogen-16 can be exploited to provide primary coolant flow distribution information.

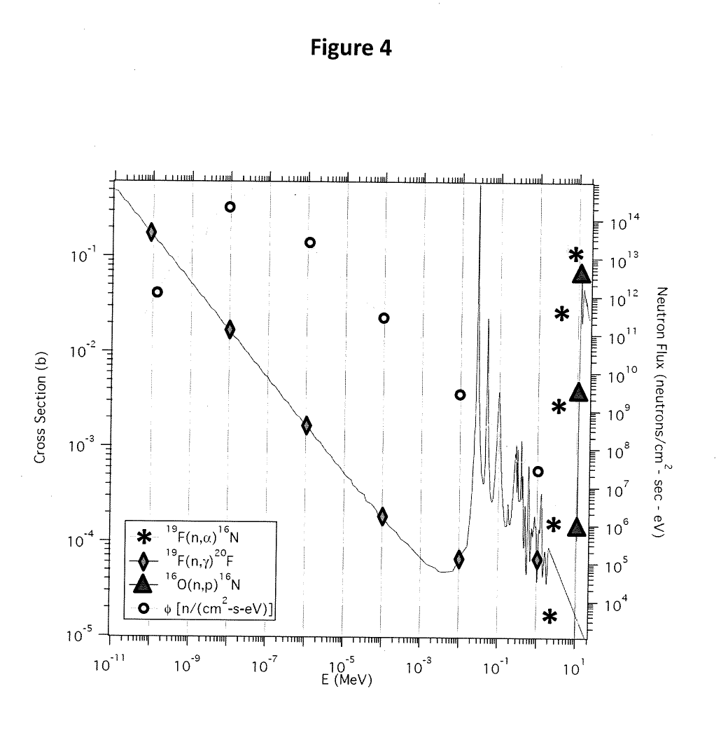

The larger signals produced by fluoride salt cooled reactor as compared to light water reactors result from the higher interaction cross sections for nitrogen-16 and fluorine-20 production by fluoride salt cooled reactors as compared to nitrogen-16 production from water-cooled reactors (see flux and cross section figure—FIG. 4). The larger signals enable higher measurement accuracy using the single point measurement techniques described in the prior art.

The method can further provide flow distribution information of the primary coolant by exploiting the differential attenuation of the gamma radiation from nitrogen-16 and fluorine-20 activity by the coolant itself and the coolant pipe wall combined with the multiplicity of energy sensitive gamma detectors around the pipe. This technique is referred to as flow mapping via multi energy gamma emission tomography. An example of flow mapping via multi energy gamma emission tomography is described in IAEA-TECDOC-1589 titled “Industrial Process Gamma Tomography,” which is incorporated herein by reference. Briefly, “Industrial Process Gamma Tomography” describes both detector configurations and signal extraction methods for gamma emission tomography.

A multiplicity of detectors would not have been effective for flow mapping in water cooled reactors as nearly all of the gamma ray attenuation occurs in the thick primary coolant pipe walls, which are necessary due to the high coolant pressure of water cooled reactors. In contrast, the low-pressure of fluoride salt cooled reactors coupled with the higher atomic number higher density of fluoride salt coolants results in a statistically significant portion of the gamma ray attenuation occurring within the coolant. The gamma attenuation by the coolant is the key feature that enables mapping the activity within the coolant by multiple detectors located around the piping.

The higher energy gamma rays of nitrogen-16 will have less self-attenuation with the coolant and by the pipe wall and will thus be less sensitive to flow distribution patterns within the pipe. The lower energy gamma ray of fluorine-20, in contrast, provides flow information more heavily biased towards flow on the side of the pipe closest to the detector. Cross-correlation between upstream gamma detectors located at one azimuthal position around the pipe and another azimuthal position downstream indicates swirl of the primary coolant. Further, the differential correlation between fluorine-20 gamma rays and nitrogen-16 gamma rays provides information on the distance from the pipe wall of the swirl. Having several gamma ray detectors (2) located in two rings around the pipe (one downstream of the other) thus enables augmenting the gamma ray correlation signal with flow distribution information increasing the accuracy of the flow measurement.

Any measurement drift in the relative intensity of the 6.123 MeV and 7.115 MeV gamma rays emitted by nitrogen-16 decays can be used to calibrate the measurement system stability. The ratio of the intensity of the nitrogen-16 decay gamma rays is constant. Any shift in the measured ratio of the intensity of the two gamma rays thus represents a drift in gain of the measurement electronics, which can be compensated for by applying an energy dependent linear correction factor derived from the shift in the currently measured intensity ratio and the originally measured intensity ratio.

### EXAMPLES

### Example 1

The mass attenuation coefficient for a 1.6 MeV gamma ray in FLiBe (lithium-7 fluoride and beryllium fluoride) will be ˜0.05 cm²/g and that of a 6 MeV gamma ray 0.025 cm²/g. The density of FLiBe at 700° C. is ˜1.95 g/cm³. The interaction of gamma rays is described by an exponential function. A 6 MeV gamma ray being emitted radially outward from the center of a 100 cm diameter pipe has a ˜12 times greater probability of reaching the exterior of the pipe than a 1.6 MeV gamma ray. Also, a center located 1.6 MeV gamma ray being emitted radially has only a ˜0.7% chance of reaching the exterior, yet a gamma ray being emitted radially 5 cm from the surface has a ˜61% chance of reaching the surface. In contrast, a 6 MeV gamma ray being emitted radially has only a ˜8.7% chance of reaching the exterior, yet a gamma ray being emitted radially 5 cm from the surface has a ˜78% chance of reaching the surface. Incorporating an energy dependent weighting factor into the flow correlation function, thus, provides information about the change in the flow distribution within the pipe (e.g. swirl) over the distance of the measurement.

Thus, while there have been described what are presently believed to be the preferred embodiments of the invention, changes and modifications can be made to the invention and other embodiments will be known to those skilled in the art, which fall within the spirit of the invention, and it is intended to include all such other changes and modifications and embodiments as come within the scope of the claims as set forth herein below.

What is claimed is:

1. A method for measuring the primary coolant flow rate within a coolant loop of a Fluoride salt-cooled High-temperature Reactor (FHR), the method comprising:
i. detecting gamma radiation emanating from nitrogen-16 activity and fluorine-20 activity within the reactor coolant at a first position along the reactor coolant loop;
ii. detecting gamma radiation emanating from nitrogen-16 activity and fluorine-20 activity within the reactor coolant at a second position along the reactor coolant loop downstream of said first position; and
iii. cross-correlating the gamma radiation detected from the first position and second position, thereby determining the transit time of corresponding gamma activity perturbations viewed at the two detector locations.

2. The method according to claim 1, wherein 6.123 MeV gamma rays are detected from nitrogen-16 activity.

3. The method according to claim 1, wherein the 7.115 MeV gamma rays are detected from nitrogen-16 activity.

4. The method according to claim 1, wherein 6.123 MeV gamma rays and 7.115 MeV gamma rays are detected from nitrogen-16 activity.

5. The method according to claim 1, wherein 1.634 MeV gamma rays are detected from fluorine-20 activity.

6. The method according to claim 1, further comprising using multi (6.123 MeV, 7.115 MeV and 1.634) energy gamma emission tomography based flow mapping to provide flow distribution information of the primary coolant.

7. A method for measuring the primary coolant flow rate within a coolant loop of a Fluoride salt-cooled High-temperature Reactor (FHR), the method comprising:
i. detecting gamma radiation emanating from nitrogen-16 activity within the reactor coolant at a first position along the reactor coolant loop;
ii. detecting gamma radiation emanating from nitrogen-16 activity within the reactor coolant at a second position along the reactor coolant loop downstream of said first position; and
iii. cross-correlating the gamma radiation detected from the first position and second position, thereby determining the transit time of corresponding gamma activity perturbations viewed at the two detector locations.

8. A method for measuring the primary coolant flow rate within a coolant loop of a Fluoride salt-cooled High-temperature Reactor (FHR), the method comprising:
i. detecting gamma radiation emanating from fluorine-20 activity within the reactor coolant at a first position along the reactor coolant loop;
ii. detecting gamma radiation emanating from fluorine-20 activity within the reactor coolant at a second position along the reactor coolant loop downstream of said first position; and
iii. cross-correlating the gamma radiation detected from the first position and second position, thereby determining the transit time of corresponding gamma activity perturbations viewed at the two detector locations.
